(19) United States
(12) Patent Application Publication
(10) Pub. No.: US 2004/0225237 A1
(43) Pub. Date: Nov. 11, 2004

(54) Method for treatment of patients having problems in motoric functions

(76) Inventor: Nola Keren, Nesher (IL)

Correspondence Address: BLANK ROME LLP, 600 NEW HAMPSHIRE AVENUE, N.W., WASHINGTON, DC, 20037, US

(21) Appl. No.: 10/772,385

(22) Filed: Feb. 6, 2004

Related U.S. Application Data
(60) Provisional application No. 60/445,254, filed on Feb. 6, 2003.

(51) Int. Cl. A61H 1/02

(52) U.S. Cl. 601/1

(57) ABSTRACT

A chain treatment method reduces muscle tonus, reduces joint contractions, acquires body symmetry, and improves motor function and coordination in patients having problems of motor functions, such as cerebral palsy or scoliosis. The method comprises a routine having three interrelated and interdependent states: relaxation, stretching, and then fixing the results obtained after the relaxation and stretching. The relaxation state comprises applying pressure on all points of influence on the body of the patient. The stretching state comprises stretching the body of the patient by hanging the patient on a horizontal bar with the arms in a substantially vertical position. And the fixing state comprises hydrotherapy where the patient is suspended in a pool of water at about 34°-36° C. with the therapist holding the patient under the head and coccyx. The method is performed in sequential order from relaxation to stretching and then to fixing.

### FIELD OF THE INVENTION

The present invention relates is a method for treating patients having motor function problems, such as those having cerebral palsy. In particular, the present invention uses a chain treatment method to reduce muscle tonus, reduce joint contractions, acquire body symmetry, and improve motor function and coordination, which is especially useful for patients having motor function problems.

### BACKGROUND OF THE INVENTION

Cerebral palsy is a condition usually caused by brain injury, which is outwardly manifested by failure of motor functions, coordination, and symmetry. Spastic cerebral palsy is characterized by dynamic contractures of the muscles, which impair or completely inhibit the sufferer's ability to use his or her muscles. Generally, muscle growth is impaired such that the longitudinal muscles become shorter relative to their associated bones as the patient grows older. Where the leg muscles are affected, the mobility of the sufferer can be severely reduced. Conventional attempts to cure this defect and to restore a measure of normal mobility typically have involved surgical intervention to alter the lengths of the tendons once the stage has been reached at which the knee joint can no longer be straightened or the sufferer can only walk on tiptoe.

There remains a need for a treatment, which allows the muscles to grow normally, to reduce joint contractions, and to improve motor function and coordination in a patient thereby removing, or at least minimizing the need to resort to surgical intervention. Moreover, there remains a need for a treatment, which can augment surgical intervention to improve the mobility of the sufferer.

### SUMMARY OF THE INVENTION

The present invention provides a method for treating cerebral palsy (which may be abbreviated as “CP”) through a specially designed method of treatment, referred to here as a chain treatment method. The method reduces muscle tonus, thereby effecting a fundamental change in the development of the patient suffering from cerebral palsy. The chain treatment method also reduces joint contractions, acquires body symmetry, and improves motor function and coordination, which is especially useful for patients having motor function problems.

The chain treatment method is a routine having three basic interrelated and interdependent states: 1) relaxation; 2) stretching; and 3) fixing. The relaxation state comprises applying pressure on all points of influence on the body of the patient. The stretching state comprises stretching the body of the patient by hanging the patient on a horizontal bar with the arms in a substantially vertical position. And the fixing state comprises hydrotherapy where the patient is suspended in a pool of water at about 34° C. with the therapist holding the patient under the head and coccyx. The method is performed in sequential order from relaxation to stretching to fixing. The method can also be repeated several times in this prescribed sequential order, hence, it is referred to as a chain treatment method.

The treatment produces positive results within a short period of time. At individual contact with the patient, the therapist builds a certain chain or “matrix” of interrelated and interdependent influences. This, in turn, leads to improvement of the general condition of the patient. The present method can be used for all forms of cerebral palsy, including quadriplegia, diplegia, hemiplegia, and monoplegia. The present method can also be used to treat other impairments of motor functions and/or coordination, including spinal problems such as scoliosis.

### BRIEF DESCRIPTION OF THE DRAWINGS

FIG. 1 shows the flow chart of the chain treatment method;

FIGS. 2 and 3 show the points of influence on the anterior of the patient's body;

FIG. 4 shows the points of influence on the lateral side of the patient's body;

FIGS. 5 and 6 shows the points of influence on the posterior of the patient's body;

FIG. 7 shows the stretching state of the present invention; and,

FIG. 8 shows the fixing state of the present invention.

FIGS. 9 and 10 show skeletal structure and joints C7, C8, T1.

### DETAILED DESCRIPTION OF THE PREFERRED EMBODIMENT

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

I. Chain Treatment Method

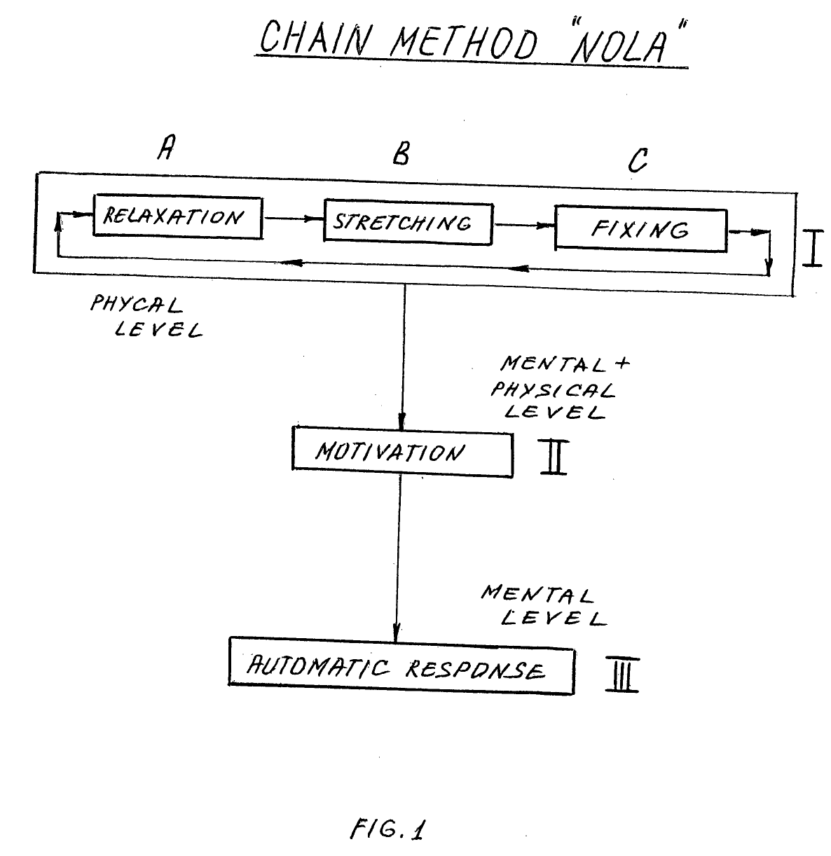

Turning to the drawings, FIG. 1 shows the chain treatment method in accordance with the preferred embodiment of the invention. The method consists of three interrelated and interdependent states (influences on the muscles), which have identical goals. Together, these states form a closed chain. A primary goal of the method is to treat patients suffering from different types of cerebral palsy, impaired motor function, and impaired coordination. Each part of the chain is a complex of influences based on non-traditional methods.

FIG. 1 shows all the states of the chain influences. The entire treatment starts with a simple set of routine influences according to the steps or states A, B, C of the chain, which means that the muscles should be kept in three interrelated and interdependent conditions: A—relaxation; B—stretching; and C—fixing.

The chain starts with state A, advances to the state B, and is fixed by the state C. The chain can be repeated by returning to state A. The chain A, B,C is preferably carried out once a day for 5-28 days or once a week until progress is noted in the patient's condition. The brain receives different reactions from each influence (A, B, C) separately. However, only when the three states or influences are practiced as an indivisible unit do they stimulate the brain to give a feedback, which results in a fundamental change in the general condition of the patient's body. Each state (A,B,C) is effective in and of itself. However, only when all three states are used together as prescribed, are the goals achieved within a relatively short period of time without regression, as reflected in the examples given below.

A. State A—Relaxation

Muscle tonus or contracture and joint contractions are the most common and serious complications of cerebral palsy. Growing bones in a normal child stretches the body's muscles and tendons through running and walking and other daily activities. This ensures that muscles will grow at the same rate. But in children with cerebral palsy, spasticity prevents stretching and, as a result, muscles do not grow fast enough to keep up with lengthening bones. The resulting muscle tonus can disrupt balance and trigger loss of motor abilities.

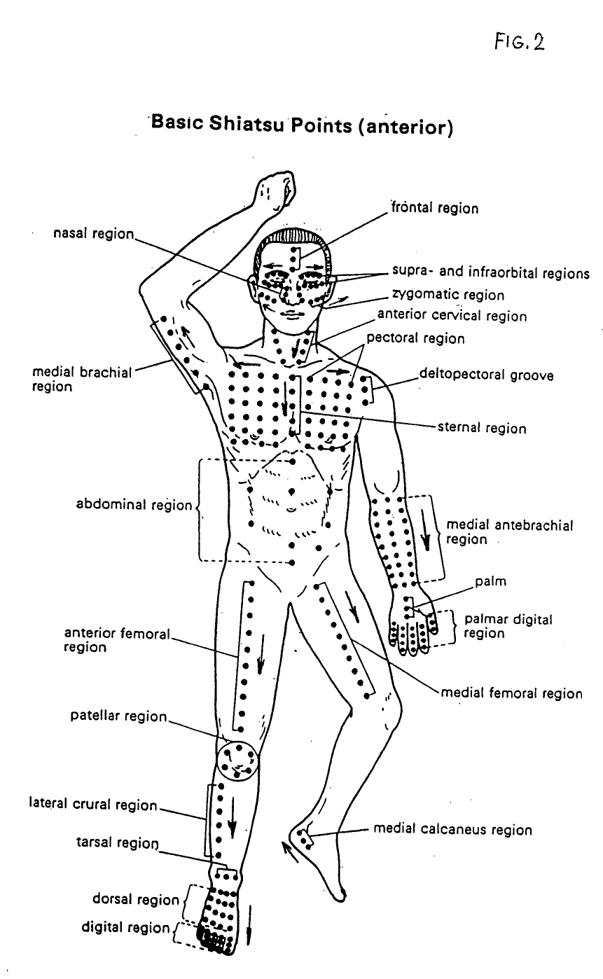

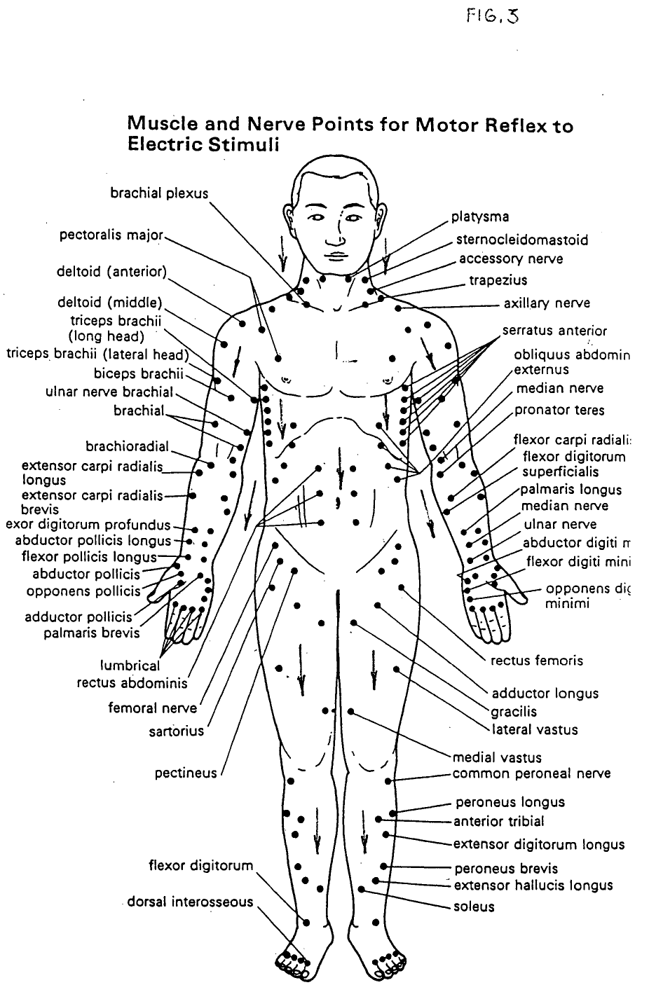

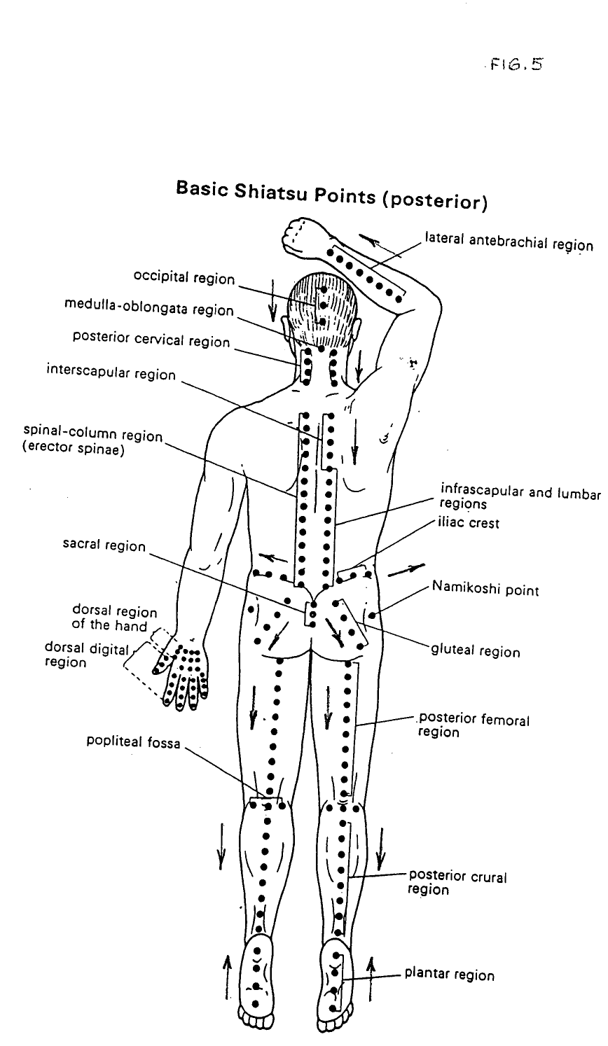

The point influences shown in FIGS. 2-6 are used for relaxation by stimulating the body to thereby reduce muscle tonus. The arrows in the figures show the direction of the point influence. The treatment, which is further referred to as a point influence, includes applying pressure on different points of influence that are shown in FIGS. 2-6. Unlike conventional acupressure methods that apply pressure to separate groups of points, such as the torso, arm, leg, lower back, tennis elbow, shoulders, or neck, the treatment of the present invention preferably includes pressure from points of influence from substantially all groups of points, and even more preferably from all points of interest from all groups of points. Treatment of all available points is required for relaxation of all groups of muscles and general relaxation of the body.

In state A, the patient's body is lying on his back in a passive horizontal position. Point influence of the patient starts from the top of the head, and then gradually moves to the face, neck, chest, abdomen, pelvis, hips, knees, feet (posterior, anterior, lateral muscle and nerve points of motor function are indicated with arrows). It continues to the upper limbs from the shoulder toward the wrist and palm of the hand (FIG. 2-6).

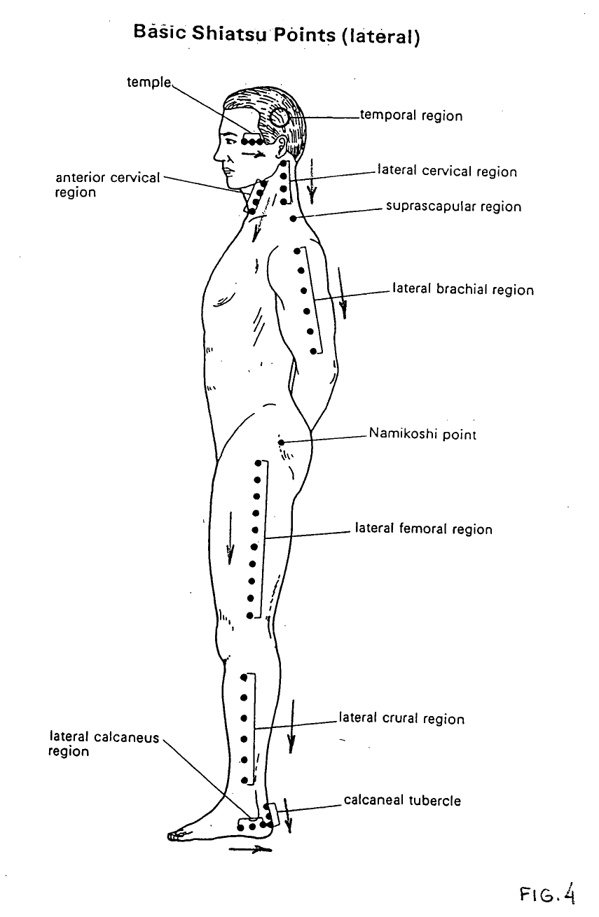

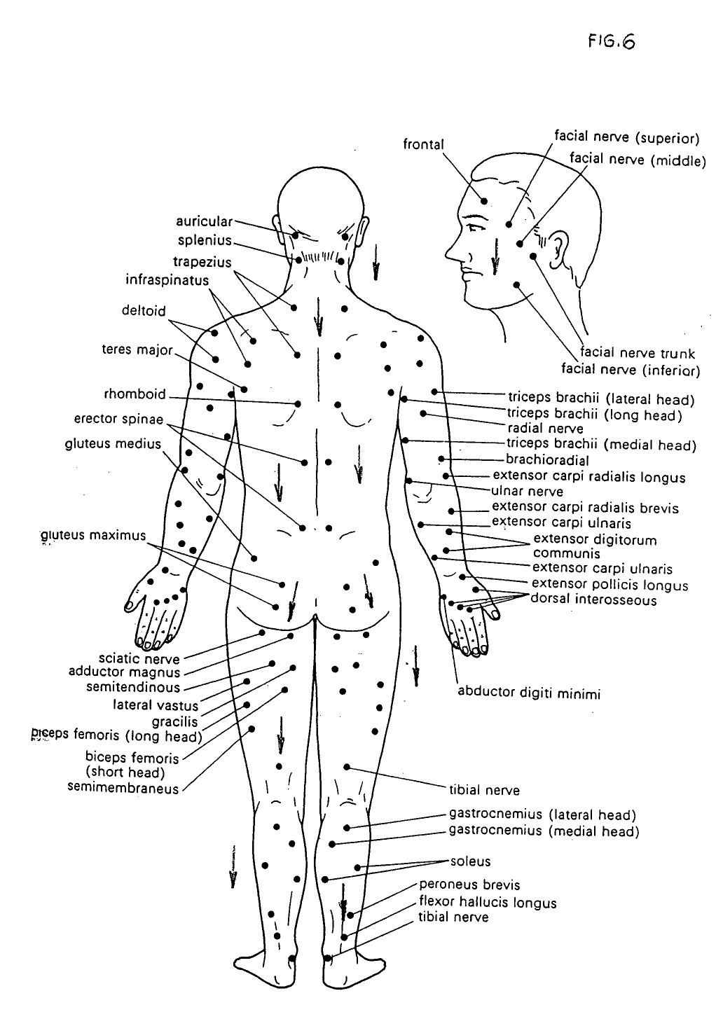

The patient should then be turned first to his right side (FIG. 4) and point influences should be treated starting from the top: neck, chest, abdomen, hip, knee, feet, and hand. In the next stage, the patient should be turned to his left side and the procedure should be repeated as for the right side. Afterwards, the patient should be slowly turned on the abdomen. The point influence proceeds from head and neck along the back to the lower back, buttocks, hips, knees, Achilles tendons, and feet (FIG. 6). Preferably, the order of the point influences is strictly kept.

State A treatment preferably takes about 50-60 minutes. In state A, perpendicular influences with gentle vibrations are preferably used, applied by thumb. The point influence is proportional to the condition of the patient, i.e., the more spastic the condition of the patient, the deeper the point influence. Point influences are preferably performed at least once a week, and most preferably reinforced by home exercises. Relaxation reduces general muscle tonus and joint contractions since the pressure, when applied to a point of influence, relaxes muscle tonus.

B. State B—Stretching

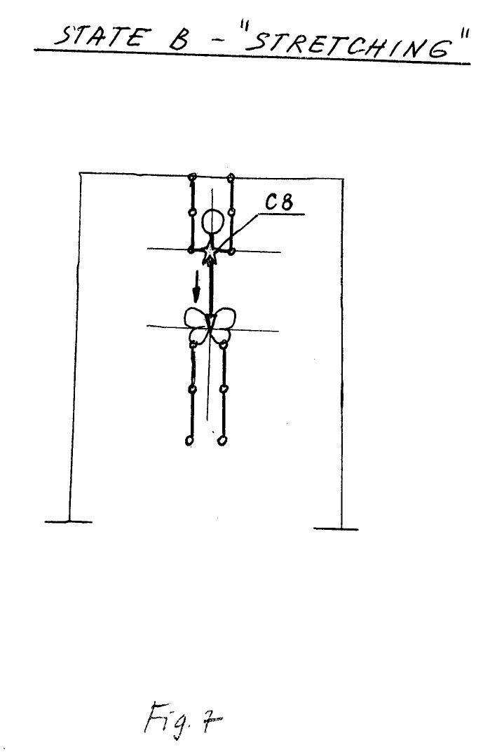

The main position in state B is body stretching, which is preferably performed by hanging on a horizontal bar. FIG. 7 shows a patient hanging on a horizontal bar with outstretched arms grasping the bar and the rest of the body hanging by the arms. Importantly, the patient's body must be in a vertical position. It is also necessary that the patient's arms be kept vertical. A therapist may need to assist the patient in keeping the arms vertical during the hanging, especially if the patient is not able to perform this action without assistance. This position is very important because it allows all groups of muscles to be stretched. The legs preferably do not touch the floor so that all muscles are stretched.

In state B, the patient's body becomes symmetrical due to the stretching of the body by the patient's own weight. In addition, the patient's muscle tonus is also reduced. Two stretching sets should be performed twice a day, with each set lasting approximately 60-90 seconds. In the beginning of treatment, the stretching may last 5-10 seconds, and then the time is gradually increased as treatment progresses. The therapist may assist the patient, if required. Each session, the stretching is increased a little bit longer depending on the ability of a patient to keep himself stretched, depending on the degree of the spastic condition of the patient. Contrary to conventional physical therapy of cerebral palsy, which advises against hanging, it has been discovered that stretching by hanging provides a clear improvement in the condition of the patient when used in the chain treatment method. The stretching reduces general muscle tonus and joint contractions, and improves symmetry and equilibrium of the body.

C. State C—Fixing

State C comprises hydrotherapy (water treatment). A special program in a pool of water not less than 34°-36° C. The difference between body temperature and water temperature should not exceed approximately 2.5° C. in order to prevent possible shock from cold water which might bring spastic muscle condition. The water temperature should be close to body temperature, but not more than body temperature. The proper temperature prevents spastic condition while the hydrotherapy procedure with the patient improves symmetry, equilibrium etc., thereby improving the general condition of the patient.

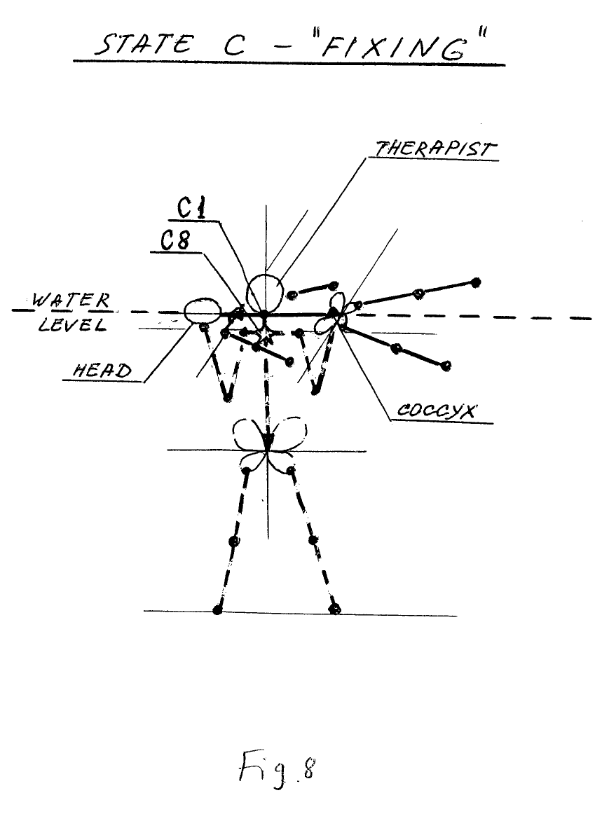

Referring to FIG. 8, during the water treatment the patient should lie horizontally on his back, and the therapist supports the patient under the head and coccyx. The water level should be at C1 (approximately at the neck level of the therapist), and the patient floats on the water with the therapist's support. The therapist applies this technique for no less than about 5-7 minutes. The therapist may use, in addition to passive support of a floating patient, such as games, exercises or other active measures. In this situation, the step C includes passive support in the beginning, active measures in the middle and again passive support in the end. The passive support in the end and in the beginning lasts 5-7 minutes.

The whole chain includes relaxation step, stretching step and fixing step. If the chain is repeated, then the sequence would be relaxation, stretching fixing, and again relaxation, stretching fixing. The fixing step lasts 5-7 min, when it includes just support of a floating patient. When this step includes also active measures, then in the beginning of fixing the floating takes 5-7 min and then follow active measures in water and then again 5-7 min of floating. The whole step still is fixing. If the chain is repeated, then after fixing by floating the patient proceeds to relaxation. State C should be performed at least once a week. Fixing reduces general muscle tonus and joint contractions, and improves symmetry, equilibrium of the body, motor functions, and coordination.

The fixing state C stabilizes the results achieved at steps A and B. Each state of the chain treatment method is preferably performed by individual work with the patient (not by group work). When used in a sequential order, the chain method influences states A, B, and C to preserve the new condition of the patient, without regression. As a result of influencing a muscle in the prescribed sequence and then repeating this sequence over a period of time, the brain begins to motivate muscle movement, as shown in part II of FIG. 1. The motivation in induced by repeated steps A-C, so that motivation is achieved through willingness and movement. In the beginning of treatment, the patient may desire to move, but is unable yet, since his muscles are too spastic. In the course of treatment, motoric function improves and, in addition to desire, the patient acquires the ability to move.

In cases where the spastic condition of the patient is not severe, motivation exists from the beginning. In these cases the chain influences, states A, B, and C, can improve the existing condition in order to achieve an “automatic response” (FIG. 1, Phase III). However, in cases where there is no motivation at all at the beginning, the chain influences create motivation, then progresses to automatic response after repeated therapy.

The following example illustrates, for instance, how motivation can be created in severe spastic cases. Assume for instance, that if a certain cerebral palsy patient is requested to take a ball, before the use of the chain treatment method, he can only look at the ball without being able to touch it. However, after the use of the chain treatment method, the patient's brain is already motivated and the patient is able to move his hand towards the direction of the ball (FIG. 1, Phase II).

The automatic response, part III, is the manifestation of the improvement of motoric functions. As the treatment progresses, it has been found that the brain's response changes from “motivation” (FIG. 1, phase II) to “automatic response” (FIG. 1, phase III). After repeated treatment, the patient can immediately take the ball upon request without difficulty (automatic response). Here, the automatic response (FIG. 1, Phase III) is the brain's voluntary feedback as the result of continuous use of regular, sequential influences on the body using the chain treatment method. Thus, as a result of the treatment, the CP progresses from motivation to automatic response. The patient's overall improved condition improves his motivation to automatic response.

As can be appreciated, the chain treatment method is a combination of completely different fields of human activities: engineering and Chinese medicine in conjunction with anatomy and physiology. The mechanical work of the human skeleton has much in common with a structure of a building. An engineer will necessarily take into account the flexibility and rigidity of the building structure, which depend on the amount of rigid and flexible joints. If an engineer's design consists only of the flexible joints, without the rigid ones, the building would collapse. Conversely, if the engineer's design consists only of the rigid joints, the same result would occur. The balance in a building is maintained because for every rigid joint there is always a group of flexible ones.

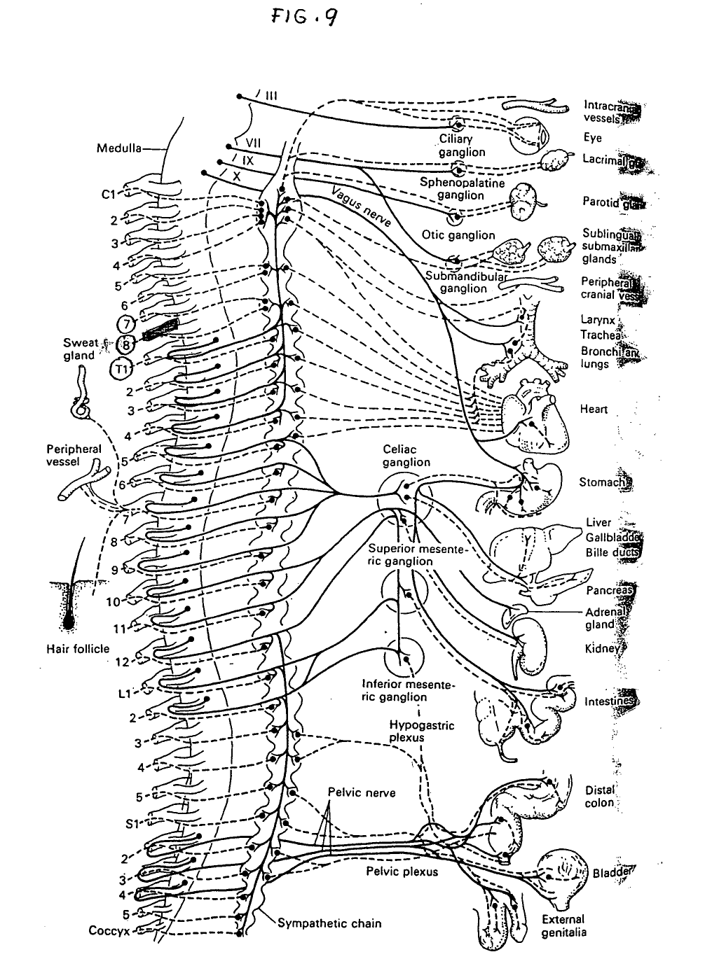

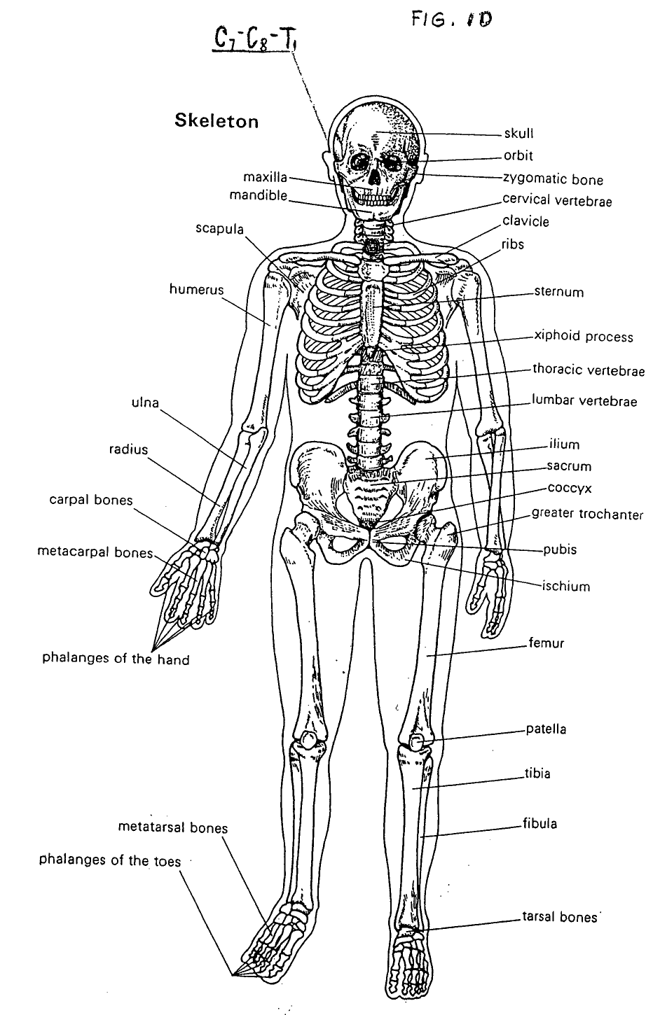

The mechanical properties of the skeleton of the human body are analogous to the building structure. All the joints of the human skeleton, whether big or small, (including the spine), are flexible. Only one joint is rigid: the “center of the body” (C7, C8, T1), around which the entire skeletal structure rotates and moves in all directions (up and down, front and back), as shown in FIGS. 9, 10.

The skeletal structures of human beings differ from each other in their mechanical work, which depends on the shoulder-girdle line that determines the pelvis line, and the walk. If the skeleton is symmetrical, the shoulder-girdle line is parallel to the pelvis line both when the person moves and when he rests, while the center always remains motionless, as shown in FIG. 9.

The cerebral palsy body, however, is not symmetrical, and the shoulder-girdle line is not parallel to the pelvis line. The use of the chain treatment method for a certain period of time changes the mechanical work of the skeleton. In other words, chain influences, used in the chain treatment method, are designed to retain the symmetry of the skeleton, and to maintain the shoulder-girdle and pelvis lines parallel. Manipulation of the shoulders-girdle and the pelvis lines brings the line of the shoulders in parallel with the line connecting between pelvis bones. Furthermore, both lines should be brought in the same plane. During treatment, the shoulder bones are displaced with respect to joint C8, which remains still. This is done by pivoting the shoulder bones with respect to joint C8, which constitutes a center. When the lines become parallel, muscle tonus and joint contractions are reduced; and symmetry, equilibrium, motor functions and coordination improve.

II. Residential Treatment Week—Matrix for Individual Treatment

In accordance with another preferred embodiment of the chain treatment method of the present invention, a more intensive treatment is provided. Within the framework of intensive treatment of patients, a special five-day matrix program, shown below in Table 1, has been designed to rapidly improve the condition of the patient. At the end of this treatment session, a new phase in the patient's condition should be discerned. In Table 1, steps 4-7 are optional

TABLE 1

| | | 1 | 2 | 3 | 4 | 5 |
|---|---|---|---|---|---|---|
| 1 | Point Influences (Relaxation) | X | | | | |
| 2 | Physical Therapy (Stretching) | | X | | | |
| 3 | Hydrotherapy (Fixing) | | | X | | |
| 4 | Alexander Technique | | | | X | |
| 5 | Influences with the Use of Essential Oils | | | | | X |
| 6 | Horse-Riding Therapy | | | | | |
| 7 | Music Therapy/Pets Therapy/Movement | | | | | |
| | Lesson | | | | | |

The intensive individual matrix program is based on the chain treatment method, where item 1 corresponds to the relaxation phase, item 2 corresponds to the stretching phase, and item 3 refers to the fixing stage. The matrix provides a more intense schedule of therapy by adding additional phases to the chain treatment method of FIG. 1, which achieve quicker improvement in the CP patient over the FIG. 1 treatment alone. Steps 4-7 are not suitable for complex treatment, which is provided by steps 1-3. Steps 4-7 are not substitutes for steps 1-3, but are optional to further assist steps 1-3 in achieving results.

The matrix schedule consists of six different kinds of treatments, given in a row. The number of patients in the group can be as many as five. Whereas the first three treatments are obligatory, and depend on the condition of the patient. It can be either music-therapy, pets-therapy or a movement lesson. This treatment, steps 1-7, is repeated at least 5 times during 5 days. The matrix program: 1) reduces general muscle tonus; 2) reduces joint contractions; 3) improves symmetry and equilibrium of the body; and 4) improves motor functions and coordination.

After the entire program, which lasts five days, a perceptible change in the condition of the patient is evident. In order to maintain the new phase in the rehabilitation of the patient, the patient's parents (or other family member(s) or personal nurse(s)) also receive a number of daily exercises that can be practiced at home.

Other matrix programs can also be devised to tailor to the patient's needs and conditions. In those programs, items 1,2, and 3 of Table 1 are compulsory. The rest of items can be recommended in addition to items 1-3. Other items may also added or removed. Each day of treatment must includes at least items 1-3, which are carried out one after another. The program can be longer or shorter than 5 days depending on the patient's particular requirements.

### III. EXAMPLES

The following examples are given to illustrate the present invention. It should be understood that the invention is not limited to the specific conditions or details described in these examples. Improvements in muscle tonus, for instance, are reflected by a gain in height.

### Example 1

The patient was received when he was 3 months old, with a diagnosis of cerebral palsy quadriplegia (spastic form), and was not able to keep his head up. His muscles were spastic. After 6 months of weekly treatment (i.e., once a week), the motor functions of the patient's body were improved: the patient was able to keep his head straight, stand on all fours, sit, and react to his surrounding. The patient also increased in height by 5 cm. Side by side with the treatment at the clinic, the patient's mother applied exercises of the chain treatment method at home.

### Example 2

The patient was received with cerebral palsy, congenital right side hemiparesis. The child had an operation of tendons under the right knee joint. The treatment started when the child was 11 years old. After six months of weekly treatment, the child's body became more symmetrical, his coordination, and his equilibrium and motor functions improved. The general muscle tonus was reduced. He also gained 5 more cm to his height.

### Example 3

The patient was received with cerebral palsy, congenital left side hemiparesis. The child experienced difficulties walking, and the mother had to accompany her to school. After 6 months of weekly treatment, the patient's muscle tonus was reduced. Coordination, equilibrium and motor functions also improved. She gained 6 cm to her height.

### Example 4

The patient was received when she was one year old, with cerebral palsy, quadriplegia spastic. She was unable to sit without assistance. She also had spastic lower and upper limbs and joint contractions. A year after the weekly treatments, the patient's muscle tonus was reduced, and her coordination, equilibrium and motor functions improved. She gained 10 cm to her height, and could stand without help. The results of the treatment eliminated the need for a surgery.

### Example 5

The patient was received at the age of seven with cerebral palsy diplegia. He was in a wheel chair. After a year of treatment with one matrix individual program, the patient's muscle tonus was reduced, and his coordination, equilibrium and motor functions improved. He gained 10 cm to his height, and started to walk with the help of a walker. The chain treatment (steps 1-3 of the matrix) was carried out once a week. After approximately 6 months of treatment, the patient received 5 days of intensive matrix program to improve the results. The reason for choosing this patient for matrix was his heavy initial condition. Without matrix, the results achieved at 12 months would have taken an additional 3 months.

### Example 6

The patient was received at the age of eight, with cerebral palsy quadriplegia spastic. In spite of her advanced age, the patient was crawling. After a year of weekly treatment, and a 5-day matrix program, the patient's muscle tonus was reduced, and her coordination, equilibrium and motor functions improved. She gained 12 cm to her height and she started to walk without help.

### Example 7

At the age of seven, the child was accepted with diagnosis of 25° scoliosis, wherein the 25° is a measure of bending of the spine. After a year of using chain treatment method once a week, the child's scoliosis improved to 13°. During that time period, the patient performed the recommended exercises of chain treatment method at home.

### Example 8

At 7 years old, the patient's handwriting was illegible. After seven treatments, once a week, using the chain treatment method, the motor function of the body improved and the child's handwriting became more legible.

### Example 9

The child was nine months old when treatment began. His standing posture was problematic. The patient was crawling backward rather than forward. After four weekly sessions, the child started crawling normally. After seven weekly sessions his posture improved and he started standing as well.

### Example 10

The patient was received with a diagnosis of muscle hypotonia scoliosis 30°. After six months of treatment, given twice a week with a complete program of home exercising according to the chain treatment method, the scoliosis was reduced to 17°. After the treatment, the patient became 6 cm taller and added 1.5 kg to his weight.

IV. Conclusion

The chain treatment method gives a patient's muscles quick physical development and prevents them from regressing. After a period of time, the brain is stimulated to provide feedback, such as chewing, speaking, sitting, or walking. The chain treatment method can be used for different forms of CP (such as quadriplegia, diplegia, hemiplegia, and monoplegia), different motor problems, different spine problems (scoliosis of varying degrees).

The method gives the patient's muscles quick physical development and keeps them from regressing and incurring side affects. The muscle tension will start to decrease, its activity increases and the patient's motor function improves. Initial results using the chain treatment method can be observed after one week, when the program is carried out according to matrix. However, it generally takes about one year for the patient to generate automatic response feedback. More intensive treatment can be applied using the matrix.

The chain treatment method has been used with approximately 85 cerebral palsy patients. It is important to note that in 90% of the cerebral palsy cases, the results correspond to the goals of the chain treatment method, which includes reducing general muscle tonus, reducing joint contractions, improving symmetry and equilibrium of the body, and improving motor functions and coordination. In most cases, the improvement of motor functions affected the improvement of the patient's weight, speech, and height (about 10-12 cm after a year of treatment). Finally, the chain treatment method has no side effects. The effectiveness of the method is evident in its ability to preserve the patient's improvement without regression.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

I claim:

1. A method for treating patients having problems in motor functions, said method comprising:
a) relaxing a muscle;
b) stretching the patient; and
c) fixing results achieved in steps a) and b).

2. The method of claim 1, wherein step a precedes step b, and step b precedes step c.

3. The method of claim 1, further comprising:
d) repeating steps a) through c).

4. The method of claim 1, wherein the relaxing step comprises applying acupressure to points of influence.

5. The method of claim 4, wherein acupressure is applied from a direction perpendicular to the patient's body with gentle vibration.

6. The method of claim 4, wherein acupressure is applied to substantially all points of influences.

7. The method of claim 1, wherein the stretching step comprises hanging the patient on a horizontal bar.

8. The method of claim 7, wherein the patient's arms are substantially vertical.

9. The method of claim 7, wherein the patient's body is substantially vertical.

10. The method of claim 7, wherein the patient hangs from the horizontal bar by his arms.

11. The method of claim 7, wherein the patient's body does not touch the floor.

12. The method of claim 1, wherein the fixing state comprises hydrotherapy.

13. The method of claim 12, wherein the hydrotherapy comprises floating the patient on water while supporting the patient under the head and coccyx.

14. The method of claim 12, wherein the hydrotherapy comprises water at a temperature of about 34°-36° C.

15. The method of claim 1, wherein the problems in motor functions result from cerebral palsy.

16. The method of claim 1, wherein steps a), b) and c) are performed by a therapist.

17. The method of claim 1, further comprising additional treatment selected from the group consisting of horse-riding therapy, music therapy, pets therapy, movement therapy, other physical therapy, and combinations thereof.

18. The method of claim 1, wherein the relaxing step lasts about 50-60 minutes.

19. The method of claim 1, wherein the stretching step lasts about 60-90 seconds.

20. The method of claim 1, wherein the fixing step lasts at least about 5 minutes.
